(19) United States
(12) Patent Application Publication
(10) Pub. No.: US 2001/0034219 A1
(43) Pub. Date: Oct. 25, 2001

(54) Internet-based enhanced radio

(76) Inventors: Carl Hewitt, San Jose, CA (US); Jonathan Fitch, Cupertino, CA (US); John Felt, Pebble Beach, CA (US)

Correspondence Address: MR. LAURIE MINTZ, 3COM CORPORATION, 5400 BAYFRONT PLAZA, SANTA CLARA,, CA, 95052, US

(21) Appl. No.: 09/777,390

(22) Filed: Feb. 5, 2001

Related U.S. Application Data
(60) Provisional application No. 60/180,581, filed on Feb. 4, 2000.

(51) Int. Cl. H04B 1/18

(52) U.S. Cl. 455/186.1; 455/73; 455/66

(57) ABSTRACT

Internet-based enhanced radio. The radio appliance, through a network interface and Internet service provider, accesses a tuning service built upon a plurality of databases. The tuning service, databases, and related enhanced services provide the listener a variety of services, complimenting AM/FM radio broadcasts and Internet radio media stream broadcasts. The radio appliance user can request additional information concerning advertised products, identify and purchase soundtracks and CDs, purchase advertised products, and respond to market research polling and surveys. The tuning service and related enhanced services can monitor, collect, process, and store user music preferences, polling and survey results, user behavior statistics, and purchase and information requests. Market research and subscriber information is stored, retrieved, and updated in databases accessible to the tuning service.

### CROSS-REFERENCE TO RELATED APPLICATION

This application claims the benefit of U.S. Provisional Application No. 60/180,581, entitled “Internet Radio,” filed on Feb. 4, 2000, the subject matter of which is incorporated herein by reference. This application is also related to application Ser. No. ______ entitled “Method for Broadcast Content Exchange” filed on even date herewith; and application Ser. No. ______ entitled “Automatic Play-list Creation” filed on even date herewith. The subject matter of all of these related applications are incorporated herein by reference.

### BACKGROUND OF THE INVENTION

1. Field of the Invention

This invention is related to AM/FM radio, more specifically, to the enhancement of the AM/FM radio listening experience.

2. Description of Background Art

Listeners of traditional AM/FM radio broadcasts are often interested in obtaining information regarding what they are listening to, including the song or CD title, artist name, advertisement information, station format and programming schedules. Listeners may be able to periodically obtain this information, but not on a regular or predictable basis. For example, DJ's often do not mention the artist's name or CD title for every track played, or the listener may not be able to clearly hear the broadcast of this information. Likewise, station identification or programming schedules may be only periodically broadcast. Additionally, the listener may desire more information about an advertised product or an advertised concert or event.

Advertisers are also constrained in their ability to gather market information and demographics regarding listener statistics and preferences, and are particularly limited in devising advertisement targeting schemes. At best, the advertiser can direct a specific advertisement to a defined target group, based upon station and advertiser market research. However, people who hear the advertisements are a heterogeneous assembly of listeners with individual tastes and preferences. Similarly, the radio stations design programming formats using the same incomplete and imprecise marketing information available to the advertisers.

What is needed is a device or method that overcomes the shortfalls of what is currently known in the art.

### SUMMARY OF THE INVENTION

The invention is a method for providing information to a radio appliance. A radio appliance is similar to a conventional radio, except it can engage in two-way communications. When the radio appliance is playing audio content that is broadcast by a radio station, such as musical works, talk shows, and advertisements, the user can decide to request information about the audio content. The request is received by a software program that has access to a database containing the requested information.

Therefore, the user can request the name of the artist of the musical work, purchasing information for the CD, or more details about an advertised product. However, before the software program can deliver the information to the listener, it must receive information from the radio appliance indicating the identity of the audio content. Once the identity is known, the software can access the database and deliver the requested information to the radio appliance.

Another aspect of the invention is the appliance itself, which has a radio and user controls. The radio is conventionally used for receiving and decoding radio waves to play audio programs including various audio content segments broadcast by radio stations. The user controls are used for requesting information about the audio content. Usually, the appliance will also have a communications device that transmits data about the information requested with the user controls.

Another embodiment of the invention uses the same three components, a radio, user controls and a communications device slightly differently. Specifically the user controls are used to access features such as adjustable volume and radio frequency tuning The communications device then transmits data indicating which features were accessed with the user controls.

### BRIEF DESCRIPTION OF THE DRAWINGS

FIG. 1 is a block diagram of the various components of the Internet-based enhanced radio system;

FIG. 2 is a block diagram of one possible configuration of the radio appliance and tuning service.

### DETAILED DESCRIPTION OF THE PREFERRED EMBODIMENT

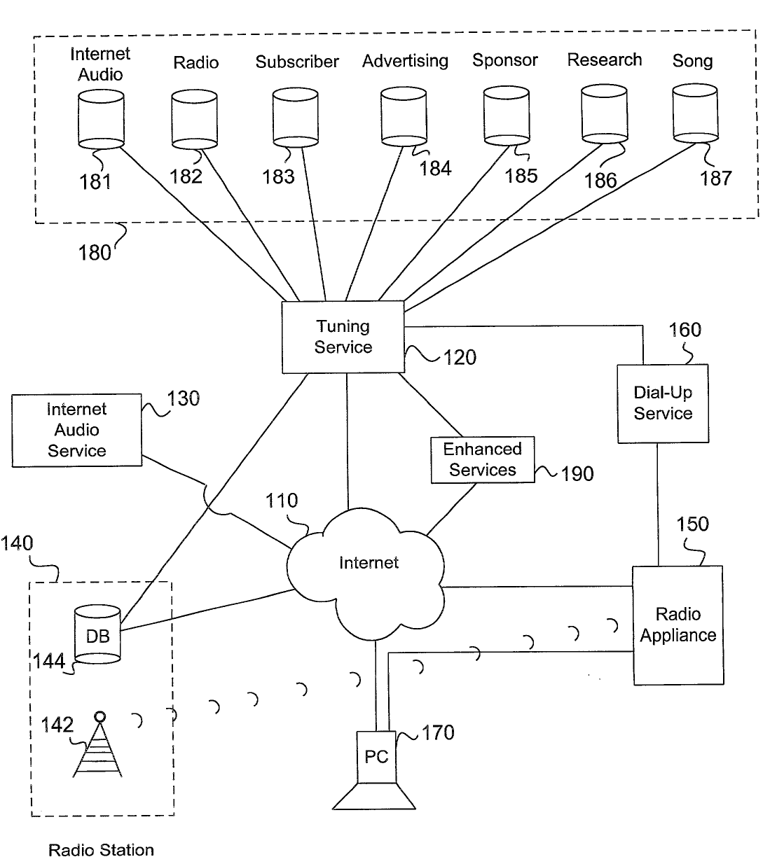

FIG. 1 shows several components of the Internet-based enhanced radio system, consisting of the Internet 110, a tuning service 120, Internet audio services 130, a conventional AM/FM radio broadcast station 140, a radio appliance 150, a dial-up service 160, a PC 170, a plurality of data bases 180 available to the tuning service 120, and enhanced services 190.

The Internet 110 is a broad network of interconnected computers and servers allowing for the transmission and exchange of Internet Protocol (IP) data between users connected to the Internet through a network service provider. Examples of network service providers are the public switched telephone network (PSTN), a cable service provider, or a satellite service provider.

The tuning service 120 is a database server with access to a plurality of databases 180 that contain information relating to content of Internet audio services 130 and broadcast radio stations 140, and registers information about listeners. Listeners can be identified either through sign-in procedures, or through unique identifiers on the radio appliance 150. Although the tuning service 120 is shown external to the radio appliance 150, its location does not affect its functionality.

The Internet audio service 130 allows users to access media on demand, simulcasts of broadcast radio programs, and unique streaming content through the Internet.

A broadcast radio station 140 provides conventional radio broadcasting using AM/FM radio waves. The radio station 140 includes a transmission tower 142 and in some cases, a radio station database 144. The database 144 might contain information such as station location, name, call letters, and broadcast frequency. The database 144 can be provided to the Internet 110 or directly to the tuning service 120 or both.

The radio appliance 150 preferably receives both conventional radio broadcasts and plays media streams carried over the Internet 110. The radio appliance 150 can be connected to any number of external networks. For example, the appliance 150 can connect to the tuning service 120 through the Internet 110 (either directly using IP protocol through the PSTN, a cable service, or a satellite service, or indirectly through a PC 170), or through a non-IP connection such as a dial-up service 160.

It should be noted that although a PC 170 is not needed to use the appliance 150, the PC 170 can enhance appliance features, allow media files to be uploaded or downloaded from the PC hard disk or other storage device to the appliance 150, and provide access to a larger display, peripheral devices, Web browsers and other applications, additional software support and additional processing power. The appliance 150 can be portable if a wireless connection is established to the tuning service 120.

The tuning service 120 accesses a plurality of databases 180. The databases 180 might include an Internet audio service database 181, a radio database 182, a subscriber database 183, an advertising database 184, a sponsor database 185, a research database 186, and a song database 187. The location of the databases 180 and the number of actual databases might vary with different embodiments of the invention. Similarly, the databases could be further divided, or combined in any number of ways. Additionally, while access to the databases is critical, maintenance of the databases can be performed by third parties.

The Internet audio service database 181 contains information about Internet audio services 130, such as general station information and media stream characteristics. The station information might include station ID, name, location, status, description and URL address. Media stream characteristics of an Internet audio station might include the number of streams, stream format, bandwidth, reliability, status, and any additional characteristics that listeners might want access to.

The radio database 182 would include radio broadcast station 140 information, such as station name, location, frequency, power, operational times, and station format, for example.

The subscriber database 183 contains listener information, such as user name, ID, address, status, billing information, authentication information, software version information and listening preferences. The subscriber database 183 would preferably not be stored locally on the appliance 150 so the listeners could access their accounts whenever they can establish communication with the tuning service 120. The same station pre-sets, for example, could be accessed from multiple appliances. Additionally, listener's might want to access their subscriber information from other devices. For example, while listeners wouldn't be able to use their broadcast radio presets on the PC 170, they would still be able to access billing information, listening preferences, etc. Additionally, if the PC 170 had the appropriate software for Internet media streams, the listener could use those Internet pre-sets.

The advertising database 184 could contain advertising media streams and information, including sponsor, description, classification, advertisement usage statistics and interactive advertisement information. The database 184 could also have elements indicating whether an advertisement is active or inactive and rules indicating how the advertisement is matched to the targeted demographic, including the play frequency and the play priority. The interactive advertisement information might include detailed product information, contact information, and facilitate direct product purchasing. For example, the enhanced services 190 could include E-commerce applications to allow listeners to purchase advertised goods or services, either directly, through a business partner, or third party.

The sponsor database 185 contains advertisement sponsor information, such as sponsor name, ID, status, type, administrative contact, billing contact, billing method, and advertisements available in the advertising database 184. Depending on the business model, the advertisements stored in the advertising database 184 could append or overlay advertisements over broadcast music, play visual advertisements while playing audio, or play advertisements while the user is changing stations or waiting for a media stream to be buffered.

Of course, the specific elements stored in the advertising database 184 and the sponsor database 185 would depend on the tuning service's 120 specific business model. For example, it is possible to only provide interactive advertising information for pre-existing radio station advertisements. In that case, description, classification, advertisement usage statistics and advertising media streams would be unnecessary.

However, the radio appliance 150 would need to be able to identify when certain advertisements are being played (in order to synchronize the interactive advertising information with the advertisements). Either an additional database 184 element would need to be added that included information about when advertisements would be played, or signals within the broadcast would need to alert the radio appliance 150 that an advertisement was being played, or pattern recognition software could be used in the enhanced services 190, or time delaying the broadcast to allow for manual recognition, etc.

The research database 186 contains marketing information gathered by the tuning service 120 on listener preference and demographics. The user might actively express certain interests by filling out surveys, being given the opportunity to vote on songs, or otherwise indicate listening preferences. Additionally, analysis of the listener's activities can generate data. For example, certain assumptions of a listener's preferences can be made by looking to the listener's pre-set stations.

Also, a detailed profile could be formed by monitoring when the radio appliance 150 was turned on, whether the volume remained constant, when the station has changed, what times the listener used the appliance 150, length of time a user spends on a visual advertisement, number of advertisements that can be played before a listener changes the station or lowers the volume, which songs or advertisements prompted the user to request more information or make a purchase, and how the listener used any other features of the radio appliance 150.

The research data could then be used, either anonymously to refine advertisements and radio programming for specific groups of consumers, or the listener can be identified so that a person's listening experience can be improved.

For example, enhanced services 190 operating with information provided by the tuning service 120 and radio appliance 150 can locate broadcast radio stations within a subscriber's coverage area which the listener might enjoy, generate play lists of songs available to the listener, possibly from the listener's personal collection, or offer products and services that might be of use to the listener, or which compete with advertised products (once again, according to the business model).

The radio appliance 150 could facilitate the purchase of many different types of goods and services. If the radio appliance 150 was able to recognize which musical works were being played, it could offer information about the artist, song, title, date of recording, title of the CD, as long as the tuning service 120 had access to the song database 187. The appliance 150 could then facilitate the purchase of CDs, concert tickets, merchandizing, etc. The recognition of musical works could be done using methods similar to what was described in connection with advertisement recognition (play-lists, identifying signals, pattern recognition software, time-delaying the broadcast, etc).

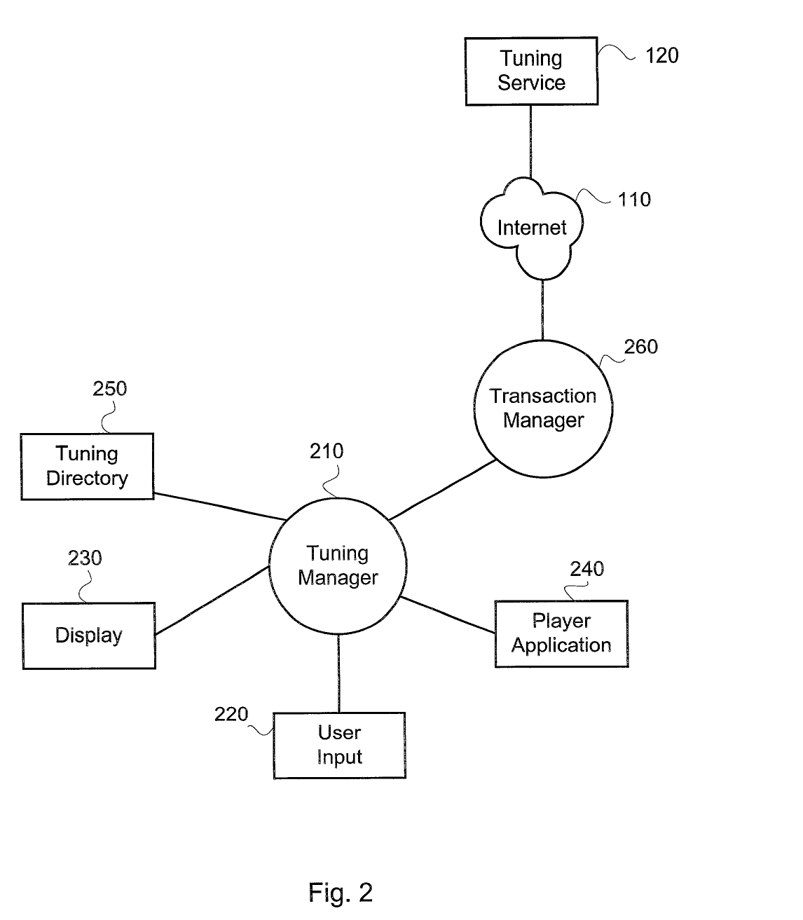

FIG. 2 shows one possible configuration of the radio appliance 150. The exchange of information between the radio appliance 150 and the tuning service 120 is enabled and managed by the tuning manager 210 and transaction manager 260 of the radio appliance 150. The tuning manager 210 is an application that provides a tuning interface to the user. It manages user input 220 and the user display 230 of the radio appliance 150, retrieves and maintains current tuning information, and launches the player application 240 required to tune a station. The tuning manager can preferably tune both Internet audio services 130 and broadcast radio stations 140.

The transaction manager 260 communicates with the tuning service 120 and, in some implementations, directly with the enhanced services 190. Preferably, the transaction manager 260 uses the IP protocol to communicate, potentially allowing it to communicate with the entire Internet 110.

The tuning directory 250 might consist of a hierarchical directory of available stations or a list of preset stations and favorite stations selected by the user. However, in a preferred embodiment of the system, the tuning service 120 would provide the entire directory of available Internet audio services 130, and the tuning directory would not be present on the device 150. Of course, the tuning service 120 would then need to be constantly maintained to ensure their directory of Internet audio services 130 remains current. In such a configuration, the device 150 itself could assist in the maintenance of the directory of Internet audio services 130. When the device 150 is unable to connect (e.g., the domain failed to resolve, the server was busy or returned a time-out error), it could report its failure to the tuning service 120. The device 150 could also report whenever a successful connection was made so that reliability statistics could be compiled.

Although the invention has been described in its presently contemplated best mode, it is clear that it is susceptible to numerous modifications, modes of operation and embodiments, all within the ability and skill of those familiar with the art and without the exercise of further inventive activity. Accordingly, that which is intended to be protected by Letters Patents is set forth in the claims and includes all variations and modifications that fall within the spirit and scope of the invention.

We claim:

1. A method for providing information to a radio appliance playing audio content broadcast by a radio station, comprising the steps of:
receiving a request for information about the audio content from the radio appliance;
receiving information from the radio appliance indicating the identity of the audio content;
accessing a database that contains the requested information; and
delivering the requested information to the radio appliance.

2. The method of claim 1, wherein the request for information, the audio program identity information, and the requested information are delivered through the Internet.

3. The method of claim 1, wherein the information indicating the identity of the audio content consists of a unique radio appliance identifier and an indicator used to identify the radio station.

4. The method of claim 1, wherein the information indicating the identity of the audio content consists of a unique radio appliance identifier and a digitized form of the audio content.

5. The method of claim 1, wherein the requested information are details of a musical work.

6. The method of claim 5, wherein the details of a musical work include the identity of a musical work and the title of a CD that contains the musical work.

7. The method of claim 5, wherein the details of a musical work include purchasing information about the musical work.

8. The method of claim 1, wherein:
the audio content is an advertisement that encourages the listener to engage in a commercial transaction; and
the requested information is details about the commercial transaction.

9. The method of claim 8, wherein the details about the commercial transaction include product details.

10. The method of claim 8, wherein the details about the commercial transaction include s information about completing the commercial transaction.

11. The method of claim 10, further comprising the step of receiving a request to complete the commercial transaction encouraged by the advertisement.

12. The method of claim 1, wherein the step of receiving information indicating the identity of the audio content is done frequently enough to identify all the audio content being played on the radio appliance.

13. The method of claim 12, further comprising the step of receiving information indicating when the radio appliance has it's volume adjusted.

14. The method of claim 12, further comprising the step of receiving information indicating when the radio appliance is tuned to a different broadcast station.

15. The method of claim 12, further comprising the step of receiving information indicating when the radio appliance is turned off.

16. An appliance, comprising:
a radio for receiving and decoding radio waves to play audio content broadcast by radio stations;
user controls to request information about the audio content.

17. The appliance of claim 16, further comprising a communications device that transmits data about the information requested with the user controls.

18. The appliance of claim 17, wherein the audio content is a musical work

19. The appliance of claim 17, wherein the audio content is an advertisement.

20. The appliance of claim 17, wherein the user controls can be used to complete a commercial transaction.

21. The appliance of claim 17, wherein:
the audio content is an advertisement that encourages the listener to engage in a commercial transaction; and
the user controls can be used to complete the commercial transaction encouraged by the advertisement.

22. An appliance, comprising:
a radio for receiving and decoding radio waves to play audio programs broadcast by radio stations, the radio having features that include adjustable volume, and radio frequency tuning;
user controls used to access the features; and
a communications device that transmits data indicating which features were accessed with the user controls.

23. A method for monitoring volume on an Internet appliance, comprising the steps of:
receiving a request to access media content available on the Internet; and
receiving information relating to how the volume was modified while the media content was received on the Internet appliance.

24. An Internet appliance, comprising:
an Internet media device for receiving and decoding media received from sources on the Internet, the Internet media device having features that include adjustable volume;
user controls used to access the features; and
a communications device that transmits data indicating which features were accessed with the user controls.

25. The Internet appliance of claim 24, wherein the Internet media device is a personal computer with a software codec.
